(19) United States
(12) Patent Application Publication
(10) Pub. No.: US 2013/0166462 A1
(43) Pub. Date: Jun. 27, 2013

(54) SYSTEM AND METHOD FOR PROCESSING AND MANAGEMENT OF FIREARM TRANSACTIONS

(71) Applicants: Travis Michael Glover, Sidney, NE (US); Michael R. Schilz, Sidney, NE (US); Earl Kenneth Davis, Sidney, NE (US); Talvin B. Lococo, Sidney, NE (US)

(72) Inventors: Travis Michael Glover, Sidney, NE (US); Michael R. Schilz, Sidney, NE (US); Earl Kenneth Davis, Sidney, NE (US); Talvin B. Lococo, Sidney, NE (US)

(21) Appl. No.: 13/335,501

(22) Filed: Dec. 22, 2011

(51) Int. Cl. G06Q 99/00

(52) U.S. Cl. 705/317

(57) ABSTRACT

A system and method of executing a firearm transaction is presented. Customer information entered into a first form is received from a user terminal. The customer information is stored in a database and associated with a serial number. When an identity of the customer is authenticated at a location of the vendor, information describing the vendor and a firearm entered into a second form is received from a vendor terminal. The information describing the vendor and the firearm is stored in the database and associated with the serial number. A background check request is transmitted to a governmental agency. The background check includes at least a portion of the customer information. When the background check indicates that the transaction may proceed, at least a portion of the customer information, the vendor information, and the firearm information is transmitted to a point of sale system.

### FIELD OF THE INVENTION

The disclosure relates in general to systems for managing transactions involving firearms and, more particularly, to a system and method for processing and managing transactions involving the purchase of a firearm from a vendor.

### BACKGROUND OF THE INVENTION

In most circumstances, transactions involving the exchange of weapons are accompanied by mandatory and comprehensive transaction records describing various attributes of the transaction. The records must be maintained by the firearms vendor for a predetermined length of time according to applicable federal, state, and/or local laws and regulations. Additionally, the required content of the transactions may be regulated by applicable law and regulation.

The maintenance of accurate firearm transaction records can be time consuming and difficult. Depending upon the type of transaction, various forms, possibly issued by different governmental agencies, may be required to be completed, verified, and stored for a predetermined period of time. The forms can be quite complex and lengthy providing ample opportunity for mistakes and errors. For vendors that enter into a large number of transactions, the maintenance of these records—some of which must be kept for many years—can be cost prohibitive and difficult, while also exposing the vendor to significant liability and potential fines.

In many circumstances, firearms transactions occur at a counter located within a vendor's store. In that case, before purchasing the firearm, a customer completes the necessary forms at the counter. If the customer requires assistance with a particular form, an employee of the vendor may be occupied for some time while assisting the customer. If the vendor is busy, both the customer and the employee can feel rushed, possibly resulting in an increased likelihood of error or mistake.

### SUMMARY OF THE INVENTION

The disclosure relates in general to systems for managing transactions involving firearms and, more particularly, to a system and method for processing and managing transactions involving the purchase of a firearm.

In one implementation, the present invention is a method of executing a transaction for a firearm between a customer and a vendor. The method includes receiving, from a user terminal, customer information entered into a first form, storing the customer information in a database, and associating the customer information with a serial number. When an identity of the customer is authenticated at a location of the vendor, the method includes receiving, from a vendor terminal, information describing the vendor and a firearm entered into a second form, storing the information describing the vendor and the firearm in the database, and associating the information describing the vendor and the firearm with the serial number. The method includes transmitting a background check request to a governmental agency. The background check includes at least a portion of the customer information. When the background check indicates that the transaction may proceed, the method includes transmitting at least a portion of the customer information, the vendor information, and the firearm information to a point of sale system.

In another implementation, the present invention includes a computer system. The computer system includes a database, and a processor connected to the database. The processor is configured to receive, from a user terminal, customer information entered into a first form, store the customer information in the database, associate the customer information with a serial number, and, when an identity of the customer is authenticated at a location of the vendor, receive, from a vendor terminal, information describing the vendor and a firearm entered into a second form. The processor is configured to store the information describing the vendor and the firearm in the database, associate the information describing the vendor and the firearm with the serial number, and transmit a background check request to a governmental agency, the background check including at least a portion of the customer information. The processor is configured to, when the background check indicates that the transaction may proceed, transmit at least a portion of the customer information, the vendor information, and the firearm information from the database to a point of sale system. In another implementation, the present invention includes a computer program storage medium usable with a programmable computer processor and having a computer readable program code embodied therein. The medium includes computer readable program code which receives, from a user terminal, customer information entered into a first form, computer readable program code which stores the customer information in a database, computer readable program code which associates the customer information with a serial number, and computer readable program code which, when an identity of the customer is authenticated at a location of the vendor, receives, from a vendor terminal, information describing the vendor and a firearm entered into a second form. The medium includes computer readable program code which stores the information describing the vendor and the firearm in the database, computer readable program code which associates the information describing the vendor and the firearm with the serial number, and computer readable program code which transmits a background check request to a governmental agency, the background check including at least a portion of the customer information. The medium includes computer readable program code which, when the background check indicates that the transaction may proceed, transmits at least a portion of the customer information, the vendor information, and the firearm information from the database to a point of sale system.

### BRIEF DESCRIPTION OF THE DRAWINGS

FIG. 1 depicts a conventional process flow associated with an existing sales process for a firearm.

FIG. 2 is a flow chart illustrating a process flow for executing a firearm transaction in accordance with the present disclosure.

FIG. 3 is a diagram illustrating the components of the present system for processing and managing firearm transactions.

FIGS. 4A-4D are screenshots showing example user interface screens of the present system.

### DETAILED DESCRIPTION OF THE DRAWINGS

The disclosure relates in general to systems for managing transactions involving firearms and, more particularly, to a system and method for processing and managing transactions involving the purchase of a firearm.

The various aspects of the disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (for example, hard disk, floppy disk, magnetic strips, and the like), optical disks (for example, compact disk (CD), digital versatile disk (DVD), and the like), smart cards, and flash memory devices (for example, card, stick, and the like). Additionally, it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

The maintenance of firearm transaction records in accordance with federal and state regulations can be an expensive and difficult process. The present system provides an automated transaction processing system that facilitates the collection of data from a potential customer, while also minimizing the occurrence of errors in that data. Using the system, common human errors (e.g., misspelled names, wrong form identification numbers, etc.) can be eliminated or otherwise minimized.

The collection of more accurate data (and the storage of that data in appropriate record-form), allows for the quick and efficient production of reports for the performance of audits. For example, the present system may be used to generate a report in a form preferred by the Bureau of Alcohol, Tobacco, and Firearms (ATF), to facilitate an audit by that organization.

Additionally, by both improving data capture accuracy and allowing for off-site completion of at least a portion of the transaction form, the duration of a particular transaction can be reduced, thereby improving the customer's experience with a particular vendor, and allowing the vendor to reduce costs associated with executing the transaction.

The present system, therefore, provides for automated processing and management of firearm transactions leading to increased efficiency, while also minimizing the occurrence of errors. The system allows a customer to complete at least a portion of the process off-site, such as, at the customer's home, allowing the customer to take the time to ensure all data is entered accurately. The system may also verify a customer's input in order to detect potential errors.

The present system is described herein as facilitating a firearm acquisition process utilizing specifically ATF E-Form 4473. E-Form 4473 is an electronic form that, in the United States, must be completed when a person purchases a firearm from a Federal Firearm License (FFL) holder. The form collects identification information for the purchaser and the vendor, as well as information describing the firearm that is the subject of the transaction. The form also includes affidavits for the customer to ensure that the customer is not barred from the purchase of firearms. After the transaction is completed, information from E-Form 4473 is recorded in the vendor's ‘bound book.’ The bound book contains a record of all the vendor's firearms transactions and may be provided to authorities upon receipt of an appropriate request or demand. Although the bound book often comprises paper copies of the completed forms, a vendor may use an electronic bound book system, wherein the information recorded in each E-Form 4473 is digitized and stored in a secure electronic repository.

Although the present system is described in terms of facilitating transactions that require the completion of E-Form 4473, it should be appreciated by persons of ordinary skill in the art that the present system may be utilized to facilitate completion of, and data gathering from, any form that may be completed as part of a transaction involving firearms. Such forms may include forms that are completed in addition to E-Form 4473, or replacements to E-Form 4473, as may be required by applicable laws and regulations. Additionally, the present system may be utilized in accordance with updated or amended versions of E-Form 4473 as made available by the ATF or other governmental agency on an ongoing basis. Accordingly, throughout the present disclosure, any references to E-Form 4473 should be considered to be equally applicable to other forms or modified E-Form 4473s that may be completed in accordance with a particular firearm transaction.

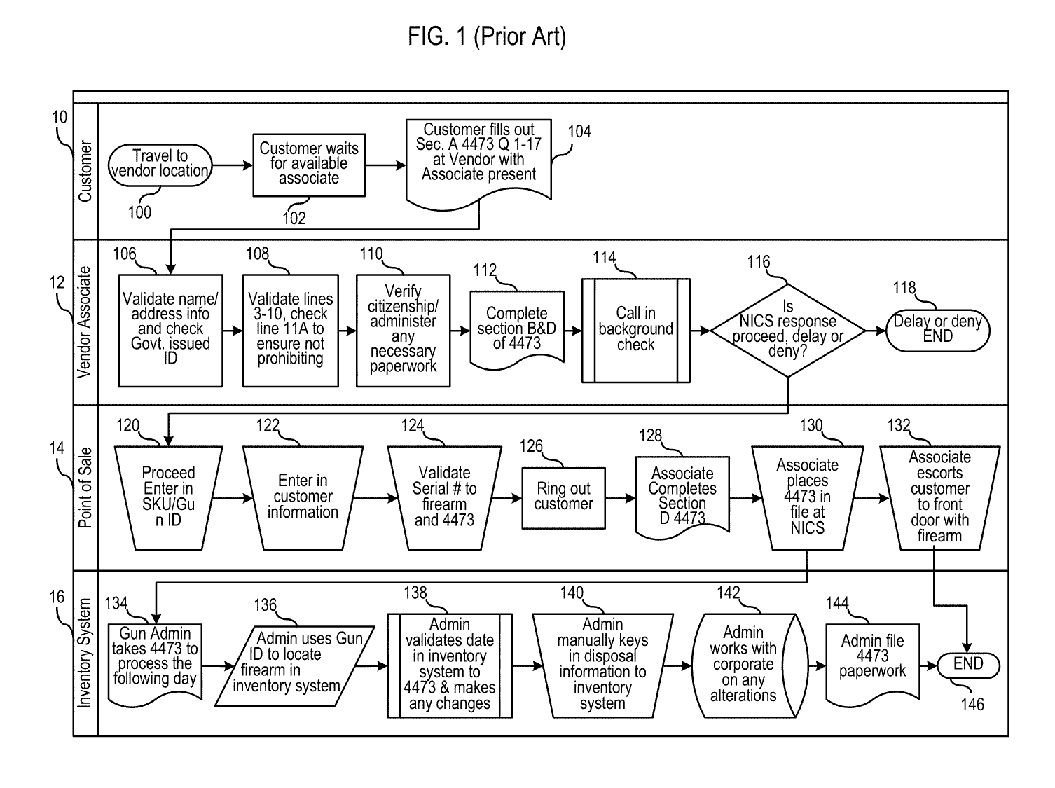

As discussed above, capturing the required transaction records for a particular firearm purchase can be laborious. To illustrate this, FIG. 1 depicts a conventional process flow associated with an existing sales process for a firearm. As shown in FIG. 1, there are four primary actors or systems that are used in executing the process: customer 10, vendor associate 12, point of sale system 14, and inventory system 16.

In a conventional approach, to purchase a firearm, customer 10 first travels to the vendor's location, and waits for an available vendor associate 12 in steps 100-102. After an associate becomes available, customer 10 interacts with vendor associate 12 to begin the firearm acquisition process. Accordingly, in step 104, customer 10 begins completing a conventional form 4473 by completing section A of the 4473 form (e.g., questions 1-17) that ask for information from customer 10. Generally, step 104 is completed with a vendor associate present (as the associate is now engaged in assisting customer 10), even though those portions of the 4473 form (in most cases) can be completed by customer 10 with little assistance from vendor associate 12. Accordingly, step 104 unnecessarily occupies vendor associate 12 and requires the presence of customer 10 in the vendor's store.

After step 104 is complete, vendor associate 12 validates the name and address information provided by customer 10 in the form (step 106) and verifies that customer 10 has completed lines 3-10 of the form, as well as verifying that customer 10 is authorized to make a firearms purchase by reviewing section 11 of the form (step 108). In step 110, the vendor verifies the customer's citizenship status and may request the completion of additional paperwork. In step 112, vendor associate 12 completes the vendor-relevant portion of the form and in step 114, vendor associate 12 calls in a background check to the appropriate governmental agency. The background check is then processed using information provided by customer 10 and vendor associate 12 on the form.

If the background check response (received in step 116) is negative, the purchase process ends and the customer is denied access to the firearm in step 118. If, however, the background check indicates that the transaction can proceed, the process moves to step 120 and the firearm transaction continues with the customer paying for the firearm at the vendor's point of sale system 14.

In step 120, using the vendor's point of sale system 14, vendor associate 12 enters information identifying the firearm being purchased into point of sale system 14. Vendor associate also enters customer information into point of sale system 14 (step 122) by visually transcribing the information from the completed form provided by the customer. Point of sale system 14 then associates the firearm identification information (e.g., a serial number) with a serial number associated with the form 4473 (step 124). At that point, the financial transaction is executed by the POS system (step 126) and vendor associate 12 completes section D of the form 4473, which identifies the weapon being sold (step 128). The completed form 4473 is then placed into a file with the National Instant Criminal Background Check System (NICS) (step 130) and customer 10 can be escorted out of the vendor's location with the purchased firearm in step 132.

After the transaction is complete, a vendor associate allocated an administrative role for the vendor begins processing the recently executed E-Form 4473 in step 134. Using the serial number of the purchased firearm, in step 136, information describing the firearm is retrieved from inventory system 16 and the data is used to validate the recently executed form 4473 in step 138. At that time, errors in the form 4473 may be corrected based upon the information retrieved from inventory system 16. After verifying the information on the form 4473, final disposal information may be entered into system 16 (step 140) and any additional updates or changes to the records associated with the transaction may be made in step 142. Final disposal of the firearm may involve entering the customer's name and address into inventory system 16 to indicate that the firearm has been sold. Finally, in step 144, the admin files the verified form 4473 for storage and the process ends in step 146.

As illustrated by the process of FIG. 1, the information associated with the firearms process must pass through a number of individuals as well as systems for validation and processing. This results in a duplication of effort and creates a substantial potential for error as the information is re-entered into the various systems. For example, the customer's information is first entered into the form 4473, which is then duplicated by vendor associate 12 into the vendor's point of sale system 14. The information provided in form 4473 describing the firearm to be purchased must then be compared with records contained in the vendor's inventory system 16, again requiring unnecessary duplication of data and use of resources.

In contrast to conventional processing methods, the present system allows for more efficient and accurate completion of the necessary forms as part of a firearm transaction. The system allows a customer to complete at least a portion of the necessary forms at a location remote from that of the final transaction location (e.g., a vendor's store) where the customer is not rushed (e.g., at the customer's home). This results in more accurate data collection from the customer. The system may also include additional programmatic checks to verify the data entered by the customer.

After the customer completes the initial portion of the transaction form or forms, the data supplied by the customer is stored in a database for future use. When the customer goes to the vendor's location to purchase a firearm, the data provided by the customer can be retrieved from the database and used to populate at least a portion of the necessary forms and/or portions of the vendor's point of sale system. The vendor can then complete the forms and execute the transaction, as described below.

After the transaction is complete, the collected information is stored into a database for long-term storage. The data can then be used to populate the vendor's ‘bound book’ (either in print or electronic form), update the vendor's inventory, and store other information associated with the transaction. Additionally, because the data is stored in an accessible database, should it be necessary to generate information pursuant to an appropriate audit request from a governmental agency, a suitable report can be quickly generated.

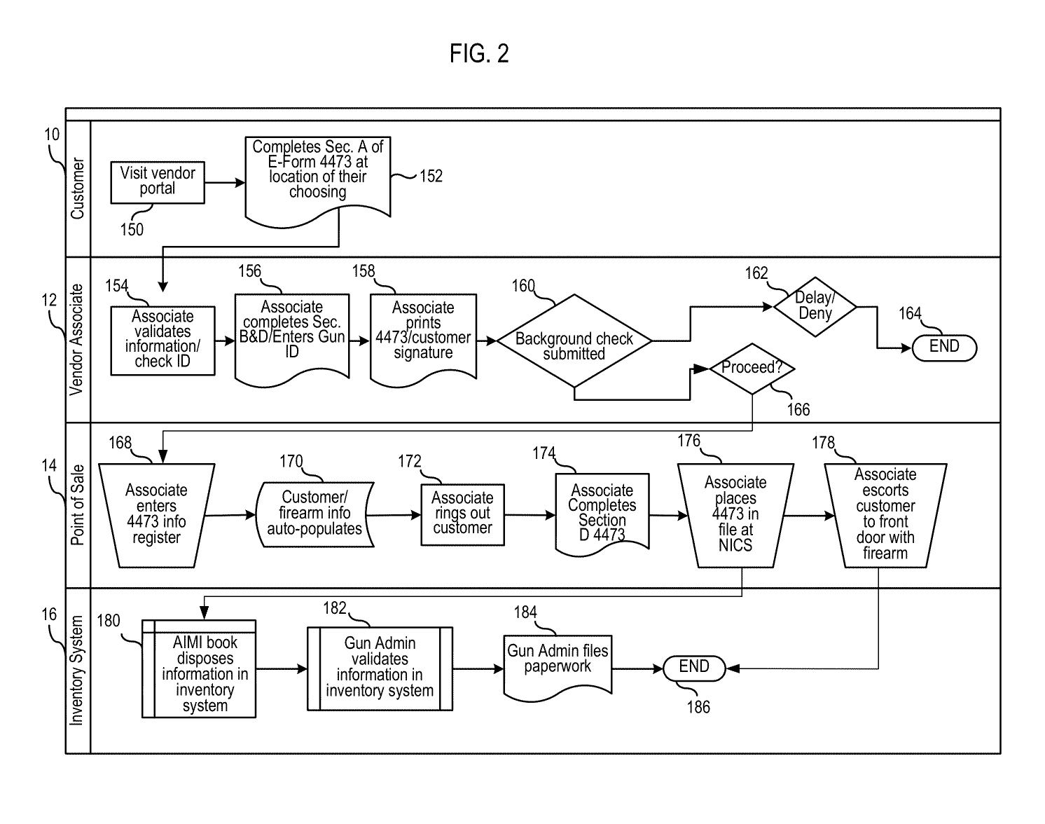

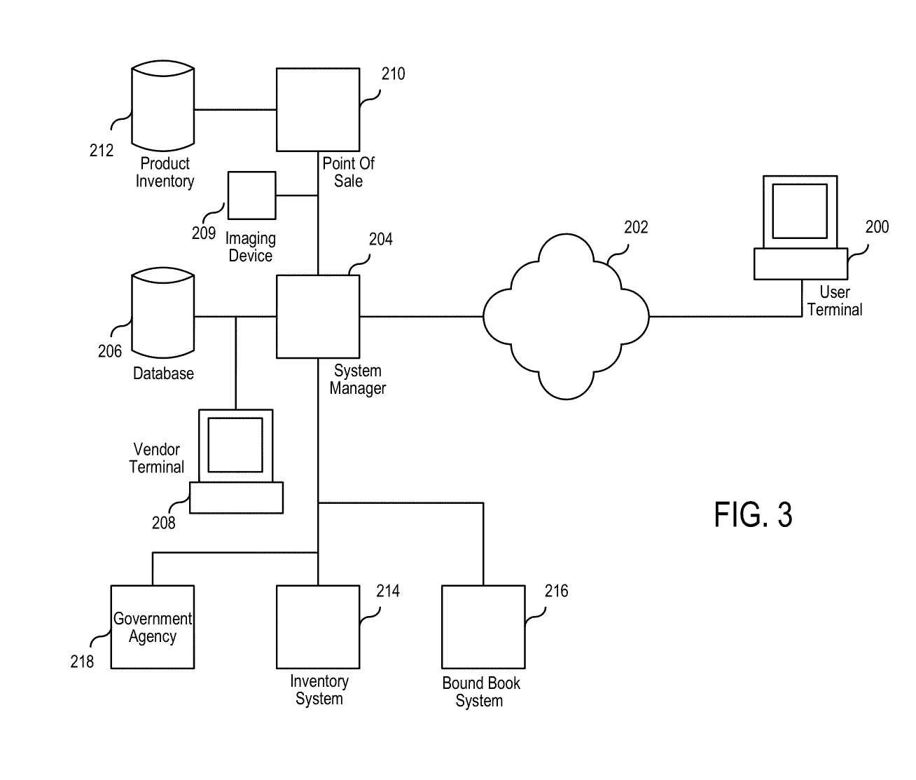

FIG. 2 is a flow chart illustrating a process flow for executing a firearm transaction in accordance with the present disclosure. In one implementation, the process may be executed by a firearm transaction system such as that illustrated in FIG. 3. In alternative implementations, the process may be executed by systems having an arrangement different from that illustrated in FIG. 3.

As shown in FIG. 2, there are four primary actors or systems that are used in executing the process: customer 10, vendor associate 12, point of sale system 14, and inventory system 16. Again, although the process is described in terms of processing a firearm transaction utilizing E-Form 4473, the process may be used to facilitate a firearm transaction requiring any documentation or forms that include portions that are customer-centric (i.e., to be filled out by the customer, or calling for the customer's information) or vendor-centric (i.e., to be filled out by a vendor associate, or calling for the vendor's information).

To begin the process, a customer decides that he or she wishes to buy a firearm from a particular vendor. At this point, the customer does not need to know the specific weapon to be purchased, only that the customer anticipates entering into a firearm transaction with a vendor at some point in the near future. Alternatively, the customer may select a particular firearm to be purchased by, for example, selecting a firearm from the vendor's website. In that case, the firearm may be placed on hold and designated for future pickup by the customer at the vendor's location. After the customer determines that he or she wishes to purchase a weapon, the customer can use the process illustrated in FIG. 2 to facilitate that transaction process.

To initiate the process, the customer accesses the vendor's portal in step 150, allowing the customer to access the vendor's firearm transaction system. The portal may include the vendor's website, or a partner's website that provides a link to the firearm transaction system. By activating the link, the customer can initiate the transaction system, which displays the appropriate user interface for completing the customer portion of the necessary transaction forms. In one implementation, the system is implemented by a computer system, such as system manager 204 (shown in FIG. 3), configured to display the appropriate user interface to the customer.

After initializing the transaction system in step 152, the customer uses the user interface to complete a first customer-centric portion of, for example, E-Form 4473 (e.g., section A of E-Form 4473). The customer can perform step 152 using any electronic device configured to communicate with the transaction system. Where the transaction system is driven by a web server, suitable electronic devices include PCs, laptops, tablets, smart phones, etc. Depending upon the particular type of device used by the customer to access the system, the output generated by the system may be specifically configured for use and display on such a device. The system may output a user interface, for example, specifically configured to display on the smaller screen of a smart phone or tablet. In other cases, the customer may utilize a computer terminal or kiosk that is provided by a vendor within one of the vendor's store location. The terminal could be positioned, for example, at a gun booth within the vendor's store.

After the customer-centric portion of E-Form 4473 is completed, the information is stored for later retrieval by the transaction processing system. The information may be stored for an extended period of time. Alternatively, the system may automatically delete the information after a set period of time (e.g., 72 hours) to ensure that the system does not store stale customer information needlessly.

After completing step 152, the customer, on his or her own schedule, can travel to one of vendor's stores in order to initiate a transaction for a particular firearm. After traveling to the vendor's store, the customer selects the firearm that the customer wishes to purchase and approaches one of the vendor's associates. The customer can then indicate to a vendor associate the firearm that the customer wishes to purchase, and also indicates that the customer has completed an initial portion of the firearm transaction process by inputting information into the forms provided by the vendor's transaction system. The associate, in step 154, uses a vendor terminal (e.g., vendor terminal 208 shown in FIG. 3) to access the information that was originally provided by the customer in step 152 after providing adequate security credentials to authenticate the vendor associate as being authorized to view the customer's information. The vendor credentials may include a username and password issued to the vendor associate, or a username and password associated with the vendor's location and shared between vendor associates. At that time, the associate can verify that the information provided by the customer is correct, for example, by checking information on the customer's driver's license against the information stored in the system. In some cases, the system may automatically verify the information inputted by the customer. Either while the customer enters the information (e.g., in step 152), or while the vendor associate verifies the information (e.g., in step 154), the system may perform automatic checks to verify that the information provided by the customer is accurate. For example, when the customer inputs his or her address information, the system may communicate with external records (e.g., provided by the United States Postal Service) to verify the customer's address and/or zip code or vendor's prior records associated with the customer to verify that the information is correct.

In one implementation, to assist the customer in authenticating his or her identity to the vendor, after completing step 152, the system allows the customer to print or save a receipt indicating that the customer has provided the customer's information to the vendor through the present system. That receipt can then be carried to the vendor's location and used by the vendor to quickly retrieve the records provided by the customer. The receipt may include a serial number, barcode, or other indicator identifying the customer's records and allowing for fast retrieval of those records. In one implementation, the receipt includes a barcode that encodes a unique identifier associated with that customer's records entered into the system. The barcode may include either encrypted or plaintext data depending upon the implementation. When the customer presents the receipt to the vendor associate, the presence of the receipt can act as a second check on the customer's identity, in combination with the customer's government-issued identification as it would be difficult for persons unknown to the customer to have access to the receipt.

After verifying customer's identify and confirming that the customer information is correct, the vendor associate completes vendor-centric portions of E-Form 4473 (e.g., sections B and D of E-Form 4473) using the vendor terminal.

With both the customer-centric and vendor-centric portions of E-Form 4473 complete, the associate can print the form using the vendor terminal. The customer then signs and dates the form in step 158. In alternative implementations, though, the form can be signed electronically, where the customer enters information through vendor terminal or another electronic device in communication with the transaction system to enter personally identifying information (e.g., signature, fingerprint, retinal scan, or other authenticating information) that can be stored in the transaction system and that satisfies requirements that the customer personally sign the E-Form 4473. At that time a camera connected to the system may also photograph the customer, to capture an image of the individual making the purchase and associate that image with the E-Form 4473 records in an appropriate storage database. Additional imaging devices (e.g., cameras or scanners) may also be used to capture images of other documents displayed or provided by the customer as part of the process, such as a driver's license to indicate the customer's identity and residence, utility bills, property deeds, or other documents that may also be used as evidence of the customer's place of residence, proof of ownership of a safe or gun lock, and/or proof of completion of required safety classes. In some cases, the camera may even record video, such as video demonstrating that the customer is familiar with the weapon, as may be required in some states.

After the E-Form 4473 is signed, the associate submits the information provided by the customer to a background check system in step 160. The background check may be performed automatically, for example, by a computer system made available by a governmental agency (e.g., governmental agency 218 of FIG. 3), such as the ATF, Federal Bureau of Investigation (FBI), NICS, or a local agency tasked with performing background checks prior to firearm acquisition. In that case, the system can format the information provided by the customer, as well as any necessary vendor-centric information, into an arrangement that is compatible with the background processing system. If the system is unavailable, the background check may be performed via telephone with the vendor associate contacting the governmental authority directly and providing the customer's information using the telephone.

After the background check is processed, the transaction system receives a response that indicates whether the background check resulted in the customer being approved or certified for the firearm transaction or whether the transaction is to be denied or delayed. If the response indicates that the transaction is to be delayed or denied in step 162, the transaction is terminated in step 164.

If, however, the customer is approved or certified for the transaction in step 166, the process continues with the customer being authorized to pay for the firearm. In one implementation, the customer may pay for the firearm using the same vendor terminal that was originally used in step 154 to validate the customer information on E-Form 4473. Alternatively, the customer may pay for the firearm at a POS system (e.g., a cash register or other payment system), that is in communication with the firearm transaction system. Accordingly, using the point of sale system, a vendor associate first enters the identification number of the E-Form 4473 associated with the customer into the POS system. In some cases, the identification number may be entered by hand. Alternatively, the POS system may prompt the associate with a listing of current pending and completed E-Form 4473s stored in the transaction system. The associate can then select the appropriate E-Form 4473 for the customer by selecting one form from that listing. Alternatively, where the customer pays for the firearm using the vendor terminal, the vendor terminal can simply utilize the currently active E-Form 4473 when processing the customer's payment for the firearm.

After providing the POS system with an identification number of the customer's completed E-Form 4473 in step 168, the POS system retrieves information describing the firearm and customer information from the firearm transaction system using that identification number in step 170. In one implementation, the customer information retrieved by the POS system includes the customer's full name, physical address, and phone number. The firearm information that is retrieved may include the firearm's stock-keeping unit (SKU), and complete firearm description (e.g., manufacturer, importer, make, model, type, gauge/caliber and serial number). After identifying the firearm being purchased, the POS system rings out the customer's purchase and the customer is charged for the price of the firearm in step 172. At this time, the POS system may update the vendor's inventory system to indicate that the firearm identified by the firearm's serial number has been sold and is no longer in stock.

After the purchase is complete, in step 174, the vendor associate can complete the E-Form 4473, for example by completing section D of the form. The information may be provided through the POS system directly, or through the vendor terminal.

The completed E-Form 4473 can then be filed with NICS in step 176 and the customer can be escorted out of the vendor's store in step 178.

After the transaction is complete, in step 180, information contained in the E-Form 4473 is stored within the inventory system. The information is validated by an administrator (step 182) and is filed in the vendor's storage system (step 184). The process ends at step 186 with the information contained in E-Form 4473 being filed and the firearm transaction is completed.

FIG. 3 is a diagram illustrating the components of the present system for processing and managing a firearm transaction. In this example, the system is described in terms of processing firearm transactions involving the processing of E-Form 4473, though the present system may be utilized with any other form, or combination of forms that specify particular types or categories of data that must be collected before a particular transaction can be executed.

As illustrated by FIG. 3, the system includes a number of components (e.g., user terminal 200, vendor terminal 208, system manager 204, and their respective databases) that are each configured to communicate with one another via an electronic communications network. Because the components can all be remote from one another, they may each be located in relatively disparate locations, while still working together to facilitate a particular firearm transaction. As such, a user, using the system, can complete the initial, customer-centric portions of E-Form 4473 from the comfort of his or her home, or a location of their choosing, using any suitable personal computing device, such as a smart phone, laptop, or PC. In some cases, the customer may even travel to one of the vendor's stores to complete the customer-centric portion of the form using a terminal provided at that location (for example, using a personal computer positioned at a counter associated with firearm sales within the store).

The information provided by the customer can then be stored within database 206. If the vendor has multiple locations, database 206 may be located at the vendor's headquarters, or a different database 206 may be established for each one of the vendor's stores. As such, the system may comprise a single, integrated system for the vendor, or can be distributed throughout a number of stores.

After completing the initial portion of the E-Form 4473 at the customer's location of choice, the customer can travel to one of the vendor's stores to purchase a firearm. Because, as described above, the various components of the system of FIG. 3 are interconnected, the customer can enter any of the vendor's stores and vendor associates within the stores can access the information provided by the customer to facilitate the firearm transaction process. As such, a customer could initially provide the E-Form 4473 information at a first one of the vendor's stores. But, upon discovering that the desired firearm is only available at a second of the vendor's stores, the customer can travel to that store to purchase the desired firearm. In that case, the information provided by the customer at the first store location can easily be retrieved by associates at the second store location to execute the transaction.

The system includes user terminal 200 which communicates with other components of the system through network 202. User terminal 200 is configured to allow the customer to interact with a vendor's firearm transaction system to initiate a transaction. Using user terminal 200, a customer can initiate a transaction by communicating with the vendor's system to complete at least an initial portion of the forms necessary for a particular firearm transaction.

As an example, the customer may use user terminal 200 to initially browse a vendor's website in search of a particular firearm. Upon finding the desired firearm, the customer could initiate a purchase of that firearm. Upon initiating the transaction, user terminal 200 displays a number of forms that allow the customer to supply the necessary information to execute the transaction. After the customer completes the forms, the information provided by the customer is stored until the customer can travel to the vendor's location. At the vendor's location, the information supplied by the customer can be retrieved and used to complete the transaction.

Alternatively, the customer may use user terminal 200 to provide the customer's information without having selected a particular weapon for the transaction. In that case, the customer may anticipate traveling to the vendor's location to select a firearm when there, but would prefer to complete the initial stage of the transaction in the comfort of his or her own home, for example.

Depending upon the configuration of the system, network 202 may include the Internet, a local area network, wireless communications network, or any other electronic network allowing for multiple devices to communicate with one another. User terminal 200 may include a personal computer, laptop, smart phone, tablet, or any other device configured to communicate via network 202. Accordingly, user terminal 200 may be resident in any location convenient for the customer, allowing the customer to initiate a firearm transaction from, for example, a home or office location. In some cases, though, user terminal 200 may comprise a computer terminal that is installed at a vendor's location. For example, the terminal could be a public terminal positioned at a counter inside the vendor's location allowing customers to initiate a firearm transaction using the terminal.

User terminal 200 is configured to communicate with system manager 204, which may comprise, for example, a computer server, to implement the user-side functionality of the system. For example, to initiate a transaction, a customer may use user terminal 200 to access system manager 204 to initiate a particular transaction. In response, system manager 204 may display one or more user interface screens displaying forms calling for the customer to enter information pursuant to a particular transaction. The forms may include, for example, portions of the E-Form 4473 into which the customer would ordinarily enter information, such as sections 1-17 of E-Form 4473.

The forms may be displayed using a single page on user terminal 200 or may be broken up into a number of different pages. In one example, the forms supplied by system manager 204 comprise a number of web pages through which the customer navigates while entering pertinent information into the forms. As the customer works through the various pages of different forms, system manager 204 may operate a web server and save the data supplied by the customer, thereby allowing the customer to page back and forth through the different form pages to make revisions or updates, for example, as necessary.

In one implementation, while the customer completes the customer-centric form content via user terminal 200, system manager 204 may monitor the customer's input to detect potential inconsistencies or mistakes. For example, the system can be designed to ensure consistent and acceptable data is entered by the user. The customers address, city, state, zip code and county must be confirmed by available postal service data. If the customer answers any questions in the form in a manner that would result in a sale being prohibited, the system will stop the sale and prevent the customer from proceeding. The system may also ensure that the date of birth entered by the customer qualifies the customer for a sale (e.g., that the customer is at least 18 years of age for long guns and 21 years of age for handguns) and that, if qualified, the information provided by the customer matches corresponding information provided by the vendor.

Because user terminal 200 could include any number of different devices, system manager 204 may be configured to display the form content in different arrangements based upon the user terminal 200's device type. Devices having smaller screens, for example, may be provided with form content broken up into a larger number of different pages displaying simpler content that is easier to read on a smaller screen. Conversely, when user terminal 200 comprises a desktop or laptop computer, system manager 204 may provide forms that utilize more complex user input features more suitable for display on those types of devices.

System manager 204 is configured to store information supplied by the customer in database 206. The information provided by a customer can be stored in database 206 and associated with a particular serial number. Generally, as each new E-Form 4473 is created by system manager 204 the forms are allocated sequential identification numbers. In one implementation, though, one or more system administrators may have the capability of modifying the serial numbers associated with one or more E-Form 4473s stored within database 206 to compensate for errors in the system, or the simultaneous use of paper forms by vendor. By modifying the serial numbers, the administrator can prevent overlap of serial numbers between electronic forms stored in database 206 and paper forms stored in a separate filings system. The information may be encrypted before being stored in database 206 to protect the customer's confidential information. Additionally, in one implementation, system manager 204 is configured to delete all information supplied by a customer after it goes unused for a period of time, such as 72 hours. This can be important as the information supplied by the customer includes personal information that should not be retained by system manager 204 unless necessary. Database 206 may include an Oracle, PostgreSQL, mySQL, or Microsoft SQL database system and may be configured to store data in an encrypted format to ensure its security.

The system includes vendor terminal 208 that is configured to communicate with system manager 204. Like user terminal 200, vendor terminal 208 may include any device (e.g., computer, laptop, tablet, smart phone) configured to communicate with system manager 204. When performing a firearm transaction, a salesperson can use vendor terminal 208 to retrieve the information provided by the customer. The salesperson can then verify the information provided by the customer and make any adjustments or modifications as necessary. Additionally, the salesperson can use vendor terminal 208 to complete the vendor-specific portions of E-Form 4473. After the vendor completes the vendor-specific portion, that information can be stored by system manager 204 into database 206. An imaging device 209 (e.g., a still camera, video camera, and/or scanner) may also be connected to system manager 204 to capture images relevant to the transaction. As described above, the relevant images may include still images or video of the customer, or images of papers provided by the customer as evidence of identity, residence, or completion of certain training courses, for example.

System manager 204 is also configured to communicate with point of sale system 210. POS system 210 may include cash registers positioned at check-out lanes or at gun counters within the vendor's location and are configured to execute transactions for goods sold at the vendor's location. After the E-Form 4473 has been completed by the customer and the salesperson via input provided on one or more of user terminal 200 and vendor terminal 208, POS system 210 can be used to execute the firearm transaction.

In one implementation, to initiate the transaction at POS system 210 the ID number of the record of the E-Form 4473 data stored in database 206 is supplied to POS system 210. POS system 210 then uses that identification number to issue a request to system manager 204 for information relevant to the transaction. In response to the request, system manager 204 retrieves information from the E-Form 4473 data stored in database 206 necessary for POS system 210 to process the sales transaction. The information may include a serial number for the firearm being purchased, and identification information for the customer. The identification information can be used to provide a warranty for the firearm, allow the customer to earn rewards points for the transaction, or to provide other perks to the customer.

After retrieving the firearm identification information, POS system 210 accesses product database 212 to update the vendor's available inventory information based upon the transaction. For example, upon executing the transaction, POS system 212 may cause product database 212 to reflect that the firearm identified by the serial number received from system manager 204 is no longer available in the vendor's inventory.

Upon receiving the necessary information from system manager 204, POS system 210 processes the firearm transaction by taking payment from the customer.

A vendor associate can then complete the E-Form 4473, for example, by completing section D of the form. The associate can enter the additional information into the form by handwriting on a paper copy of the form printed via system manager 204 and vendor terminal 208. Alternatively, the associate can enter the information directly into vendor terminal 208, causing the information associated with the transaction to be updated in database 206.

System manager 204 is also in communication with firearm inventory system 214 and bound book system 216. Inventory system 214 stores information describing firearms that have been sold by vendor, or are available for sale. The inventory system can store information describing each firearm, its serial, and other useful information relating to the firearm. For vendors that store electronic bound books, bound book system 216 may include an electronic database configured to securely store completed E-Forms 4473. The bound book system is configured to satisfy applicable law enforcement requirements and local regulations relating to the storage of such information.

System manager 204 also includes a communication interface that is configured to communicate with an external government agency 218, such as the ATF, that can perform background-check activities for a particular customer. To perform such a background check, system manager 204 accesses the E-Form 4473 data stored for the customer in database 206. System manager 204 retrieves the necessary information to perform the desired background check and packages that information into a form usable by government agency 218. The packaged information is then transmitted to government agency 218 so that the necessary background check can be performed. After executing the background check, government agency 218 transmits the results (e.g., proceed, delay, or deny) to system manager 204, which can then store the results in database 206. The results of the background check can then be used to determine whether the transaction is authorized to proceed.

As the record requirements for firearm transactions change, for example by modifications to the content of E-Form 4473 or the addition of new forms for collecting information pursuant to a transaction, system manager 204 can be updated so as to collect the additional required information from either the customer or the vendor associate, as necessary, via user terminal 200, vendor terminal 208, or combinations thereof. Accordingly, system manager 204 may store a number of different versions of forms, or different forms applicable to transactions occurring in different locations for use in executing any particular transaction. Depending upon any factor, such as the customer's current location, the vendor's location, time of year, type of weapon, or any other information provided by the customer, system manager 204 may use different forms for gathering information in conjunction with the transaction. Additionally, as law enforcement agencies update and change the forms associated with particular transactions, the forms stored by system manager 204 may similarly be updated to meet new requirements.

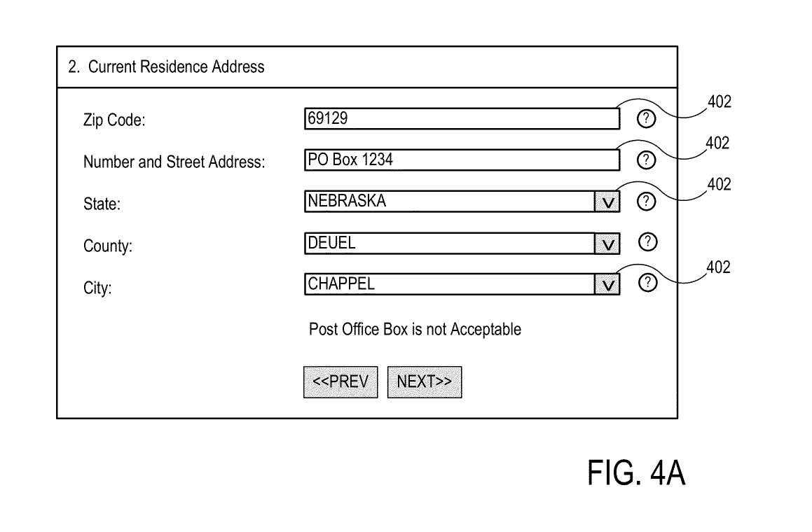

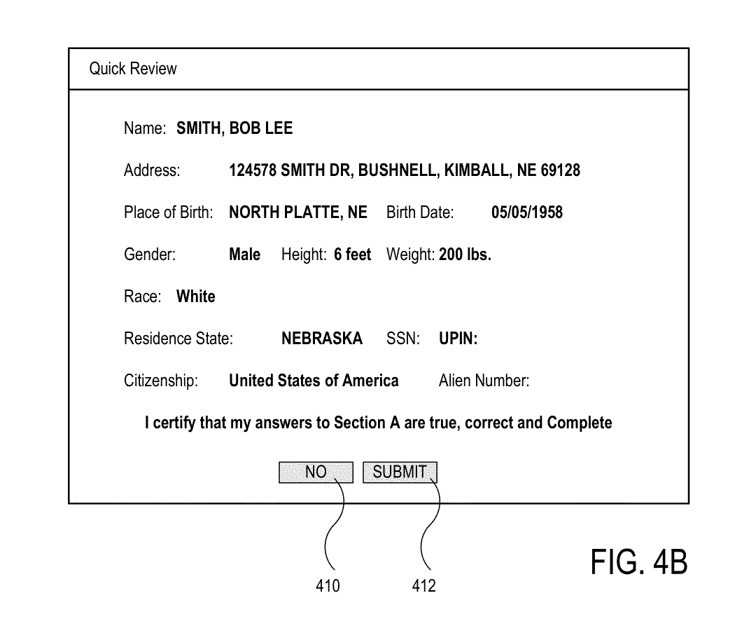

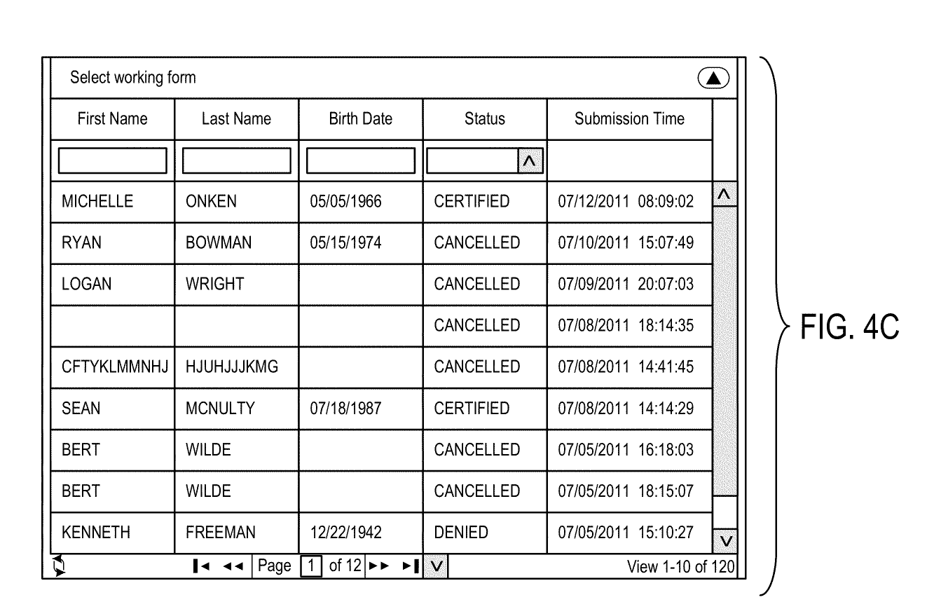

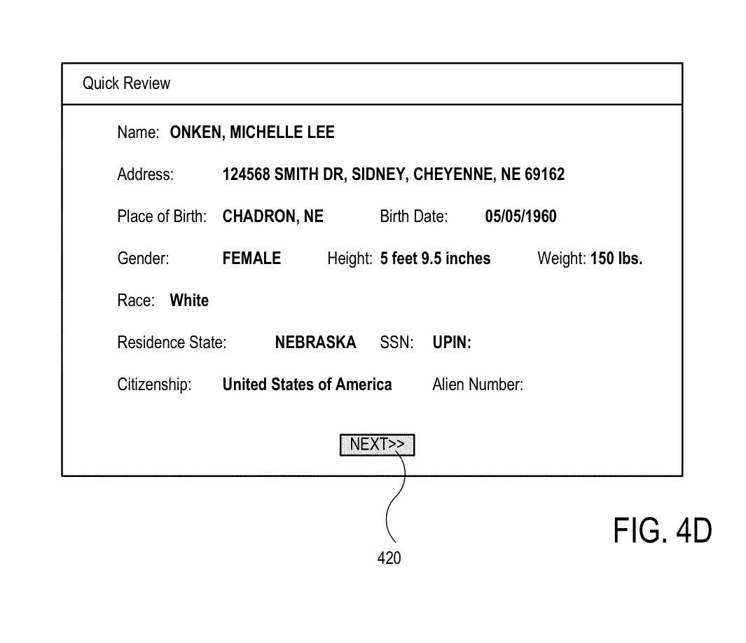

FIGS. 4A-4Dare screenshots showing example user interface screens displayed by the present system.

FIG. 4A shows a user interface screen that allows a potential customer to enter customer information into the system. The form shown in FIG. 4A only shows a subset of data that may be provided by the customer. As shown in FIG. 4A the user is presented with a number of user interface boxes 402 in which to enter various customer-centric information such as zip code, address, state, county and city. Depending upon the implementation of the system, the address data provided by the customer may be validated against available databases, such as databases that provide a listing of valid zip codes for particular counties. In some cases, the user can provide data by typing directly into text boxes. Alternatively, pull down menus, or other menu systems can be used to collected data.

In some implementations, the form may include a text box into which the customer may enter a unique personal identification number (UPIN). The UPIN provides a single reference number or identification number that can be used to uniquely identify that particular customer. If a customer, for example, has a relatively common name (e.g., John Smith), a UPIN, if provided would be used by the transaction system to distinguish the customer from other customers have the same name.

After providing the customer's information, the user is provided with an opportunity to verify that the information provided is accurate. FIG. 4B shows an example screenshot that displays a summary of information provided by the customer for validation. If the customer sees a discrepancy, or wishes to correct some of the information, the user can click on button 410 to edit the information. If the information appears to be correct, the user clicks on button 412 to submit the user's information. Upon submission, the customer information is stored into a database (e.g., database 206 shown in FIG. 3), until retrieved in conjunction with a firearm purchase.

After the customer's information is submitted and the customer has traveled to the vendor's location to purchase a firearm, after authenticating the customer's identity, a vendor associate can retrieve the information that was originally submitted by the customer using the present system. To access the customer's information, the vendor associate first logs into a vendor terminal. The terminal then provides the vendor with a listing of customers that have submitted information into the system. Such a listing is illustrated in FIG. 4C. After finding the customer's name in the listing of available customers, the vendor can select the row containing the customer's name to access the customer's information. After selecting the customer's name the system displays a review page providing the customer's information, as shown in FIG. 4D. The vendor can then review the information that was originally provided by the customer. If the information is accurate, the vendor associate can use button 420 to display additional forms allowing the vendor to enter the vendor's information as well as information describing the firearm to be purchased and can complete the transaction.

Although the present invention has been described with respect to preferred embodiment(s), any person skilled in the art will recognize that changes may be made in form and detail, and equivalents may be substituted for elements of the invention without departing from the spirit and scope of the invention. Therefore, it is intended that the invention not be limited to the particular embodiments disclosed for carrying out this invention, but will include all embodiments falling within the scope of the appended claims.

What is claimed is:

1. A method of executing a transaction for a firearm between a customer and a vendor, comprising:
receiving, from a user terminal, customer information entered into a first form;
storing the customer information in a database;
associating the customer information with a serial number;
when an identity of the customer is authenticated at a location of the vendor, receiving, from a vendor terminal, information describing the vendor and a firearm entered into a second form;
storing the information describing the vendor and the firearm in the database;
associating the information describing the vendor and the firearm with the serial number;
transmitting a background check request to a governmental agency, the background check including at least a portion of the customer information; and
when the background check indicates that the transaction may proceed, transmitting at least a portion of the customer information, the vendor information, and the firearm information to a point of sale system.

2. The method of claim 1, wherein the first form and the second form are portions of E-Form 4473.

3. The method of claim 1, including, when the identity of the customer is not authenticated within a predetermined time period, deleting the customer information from the database.

4. The method of claim 3, wherein the predetermined time period is 72 hours.

5. The method of claim 1, wherein the user terminal includes at least one of a laptop, a smart phone, and a tablet.

6. The method of claim 1, including, after transmitting at least a portion of the customer information, the vendor information, and the firearm information from the database to a point of sale system, storing at least a portion of the customer information, the vendor information, and the firearm information in an electronic bound book system.

7. A computer system, comprising:
a database;
a processor connected to the database and configured to:
receive, from a user terminal, customer information entered into a first form;
store the customer information in the database;
associate the customer information with a serial number;
when an identity of the customer is authenticated at a location of the vendor, receive, from a vendor terminal, information describing the vendor and a firearm entered into a second form;
store the information describing the vendor and the firearm in the database;
associate the information describing the vendor and the firearm with the serial number;
transmit a background check request to a governmental agency, the background check including at least a portion of the customer information; and
when the background check indicates that the transaction may proceed, transmit at least a portion of the customer information, the vendor information, and the firearm information from the database to a point of sale system.

8. The computer system of claim 7, wherein the first form and the second form are portions of E-Form 4473.

9. The computer system of claim 7, wherein, when the identity of the customer is not authenticated within a predetermined time period, the processor is configured to delete the customer information from the database.

10. The computer system of claim 9, wherein the predetermined time period is 72 hours.

11. The computer system of claim 7, wherein the user terminal includes at least one of a laptop, smart phone, and a tablet.

12. The computer system of claim 7, wherein the processor is configured to store at least a portion of the customer information, the vendor information, and the firearm information in an electronic bound book system.

13. A computer program storage medium usable with a programmable computer processor and having a computer readable program code embodied therein, comprising:
computer readable program code which receives, from a user terminal, customer information entered into a first form;
computer readable program code which stores the customer information in a database;
computer readable program code which associates the customer information with a serial number;
computer readable program code which, when an identity of the customer is authenticated at a location of the vendor, receives, from a vendor terminal, information describing the vendor and a firearm entered into a second form;
computer readable program code which stores the information describing the vendor and the firearm in the database;
computer readable program code which associates the information describing the vendor and the firearm with the serial number;
computer readable program code which transmits a background check request to a governmental agency, the background check including at least a portion of the customer information; and
computer readable program code which, when the background check indicates that the transaction may proceed, transmits at least a portion of the customer information, the vendor information, and the firearm information from the database to a point of sale system.

14. The computer program product of claim 13, wherein the first form and the second form are portions of E-Form 4473.

15. The computer program product of claim 13, including computer readable program code that, when the identity of the customer is not authenticated within a predetermined time period, deletes the customer information from the database.

16. The computer program product of claim 15, wherein the predetermined time period is 72 hours.

17. The computer program product of claim 13, wherein the user terminal includes at least one of a laptop, smart phone, and a tablet.

18. The computer program product of claim 13, including computer readable program code that, after transmitting at least a portion of the customer information, the vendor information, and the firearm information from the database to a point of sale system, stores at least a portion of the customer information, the vendor information, and the firearm information in an electronic bound book system.
